(19) United States
(12) Patent Application Publication
(10) Pub. No.: US 2009/0027283 A1
(43) Pub. Date: Jan. 29, 2009

(54) HIGH FREQUENCY WAVE ANTENNA FOR AN AUTOMOBILE

(75) Inventors: Kenichiro SHIMO, Chiyoda-ku (JP); Kazuyoshi Noda, Chiyoda-ku (JP); Takuji Hayashi, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/169,136

(22) Filed: Jul. 8, 2008

(30) Foreign Application Priority Data
Jul. 9, 2007 (JP) 2007-179706

(51) Int. Cl. H01Q 1/32; H01Q 1/02

(52) U.S. Cl. 343/704; 343/713

(57) ABSTRACT

A high frequency wave antenna for an automobile is provided, which improves antenna gain of an antenna conductor provided in a spoiler. A defogger is provided on a rear window glass plate 14, a part of a plurality of heater wires extend in a horizontal direction, a spoiler including an antenna conductor 6 embedded therein is provided above the rear window glass plate 14, at least one of a plurality of bus bars has a bus bar horizontal portion 1H extending in a horizontal direction, the bus bar horizontal portion 1H is provided in an upper region of the rear window glass plate 14, and a plurality of vertical heater wires 2 extending in a vertical direction from the bus bar horizontal portion 1H, are provided.

The present invention relates to a high frequency wave antenna for an automobile suitable to receiving Japanese terrestrial digital TV broadcasting (470 to 770 MHz), analogue TV broadcasting in UHF band (473 to 767 MHz) or U.S. digital TV broadcasting (698 to 806 MHz). Further, the present invention also relates to a rear window glass for an automobile on which a high frequency wave glass antenna for an automobile is provided.

Heretofore, a high frequency wave antenna for an automobile to receive digital TV broadcast band wave shown in FIG. 2 is reported in WO2006/001486. In this prior art example, a defogger constituted by a plurality of heater wires 33 and bus bars 35 is provided on a rear window glass plate 14, and an antenna conductor 31 and a feeding point 32 is provided. A heater wire at the highest position right under the antenna conductor 31 has a meander shape. In this construction, in a digital TV broadcast band, influence of heater wires 33 and 34 to the antenna conductor 31 is reduced, and the antenna gain in the digital TV broadcast band is improved.

However, in this prior art example, since the heater wire 34 at the highest position has a meander portion and its length is longer than other heater wires, the line width of the heater wire 34 at the highest position needs to be wider to make the resistance of the entire heater wire 34 at the highest position equivalent to those of other heater wires, and accordingly, there has been a problem that the width of the heater wire 34 at the highest position prevents visibility.

It is an object of the present invention to provide a high frequency wave antenna for an automobile which solves the above-mentioned problem of prior arts.

The present invention provides a high frequency wave antenna for an automobile, comprising a plurality of heater wires and a plurality of bus bars for supplying electricity to the plurality of heater wires, the heater wires and the bus bars being provided on a rear window glass plate for an automobile, the heater wires and the bus bars constitute a defogger, a part of the heater wires extending in a horizontal direction or a substantially horizontal direction, and the antenna comprising an antenna conductor provided on an upper blank space of the rear window glass plate or in the vicinity of the rear window glass plate, the antenna being characterized in that at least one of the bus bars has a base bar horizontal portion extending in a horizontal direction or a substantially horizontal direction, the bus bar horizontal portion is provided in the upper region of the rear window glass, and a plurality of vertical heater wires extending in a vertical direction or a substantially vertical direction starting from the bus bar horizontal portion.

In the present invention, by employing the above construction, it is possible to reduce the influence of the defogger on the antenna performance of the antenna conductor, and to significantly improve antenna gain for the terrestrial digital TV broadcasting or the U.S. digital TV broadcasting etc. Further, since the line width of each of plurality of vertical heater wires in the present invention can be reduced, visibility of rear window, particularly, view field and beauty of defogger region are not deteriorated.

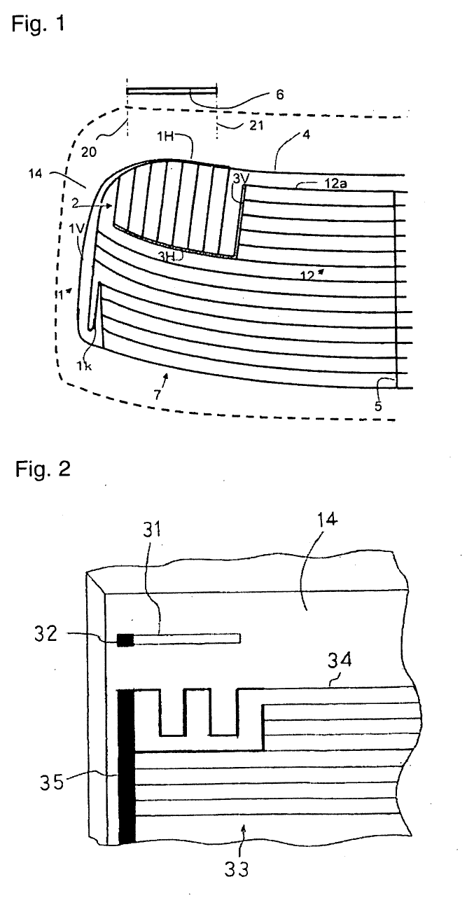

FIG. 1: A front view showing an embodiment of a high frequency wave glass antenna for an automobile of the present invention.

FIG. 2: A front view showing an example of prior art.

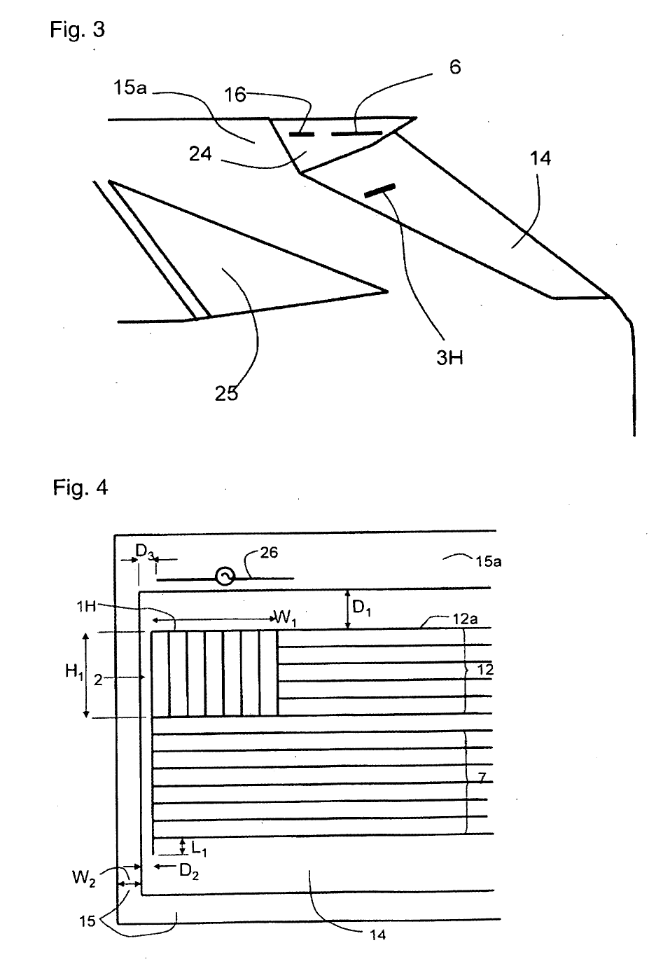

FIG. 3: A side view showing a side of rear upper portion of an automobile in an embodiment of the high frequency wave glass antenna for an automobile of the present invention (including the embodiment shown in FIG. 1).

FIG. 4: A front view showing an upper left side half of the rear portion of an automobile in Examples 1 and 2.

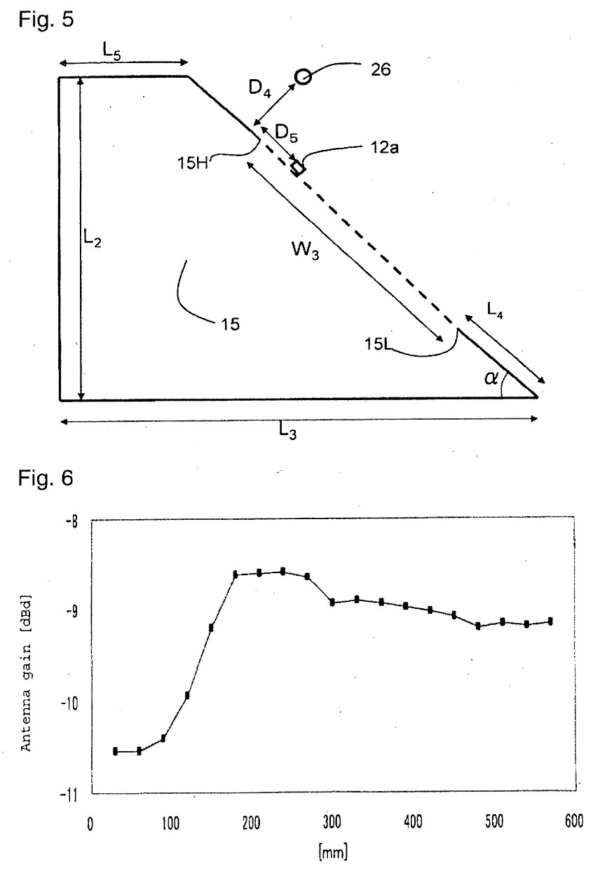

FIG. 5: A side view showing a high frequency wave antenna for an automobile shown in FIG. 4.

FIG. 6: An antenna gain-W₁ characteristic diagram (470 to 770 MHz) in Example 1.

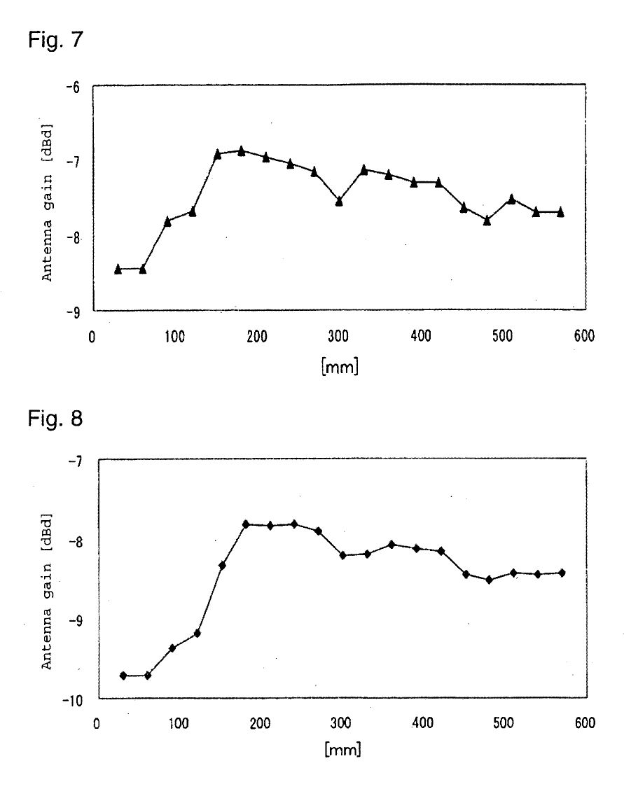

FIG. 7: An antenna gain-W₁ characteristic diagram (470 to 600 MHz) in Example 1.

FIG. 8: An antenna gain-W₁ characteristic diagram (470 to 710 MHz) in Example 1.

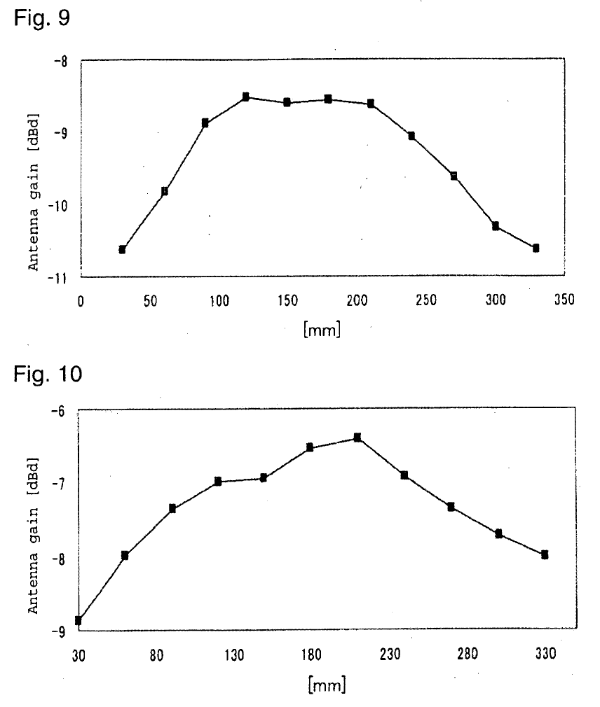

FIG. 9: An antenna gain-H₁ characteristic diagram (470 to 770 MHz) in Example 2.

FIG. 10: An antenna gain-H₁ characteristic diagram (470 to 600 MHz) in Example 2.

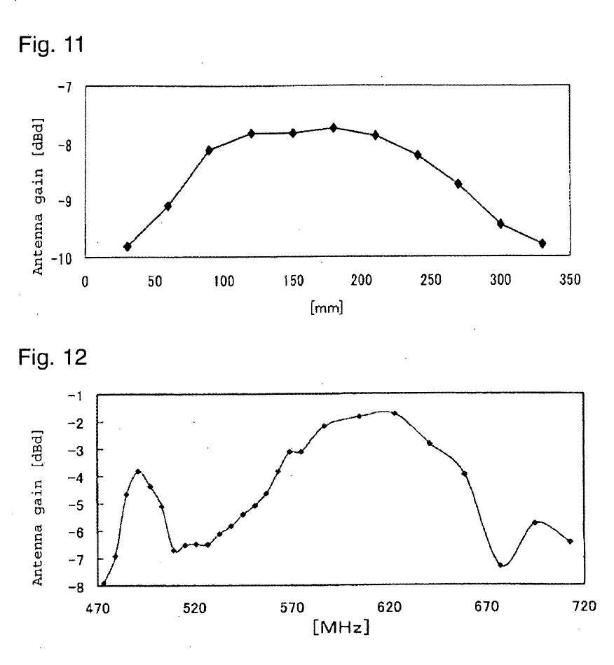

FIG. 11: An antenna gain-H₁ characteristic diagram (470 to 710 MHz) in Example 2.

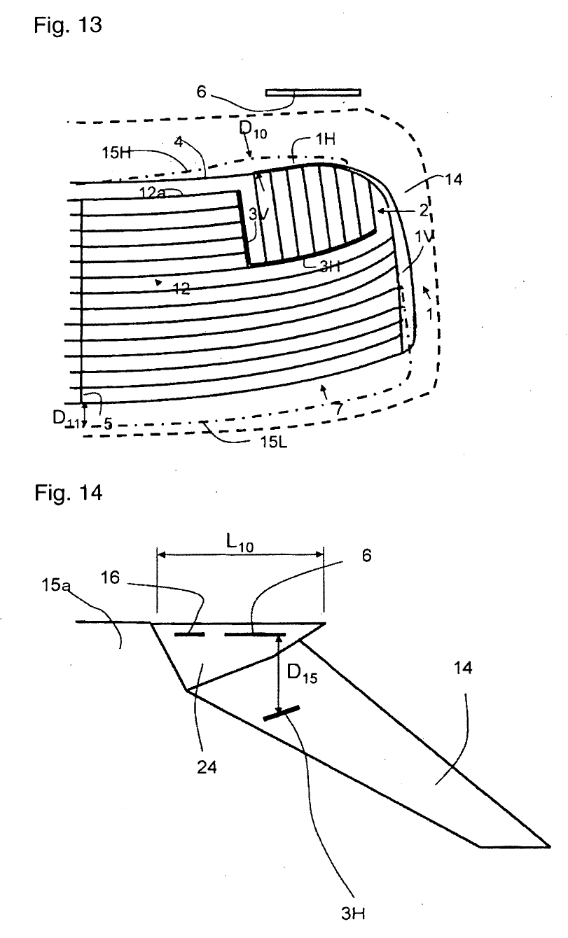

FIG. 12: An antenna gain-frequency characteristic diagram in Example 3.

FIG. 13: A front view of a rear glass plate 14 in Example 3.

FIG. 14: An enlarged side view in the vicinity of the rear window glass plate 14 shown in FIG. 3 in Example 3.

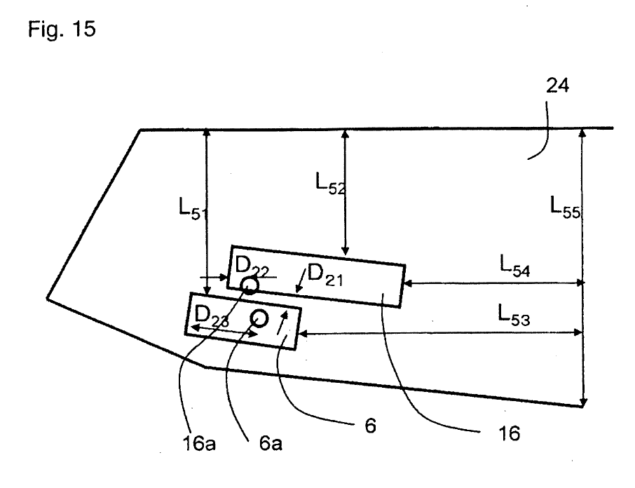

FIG. 15: A plan view showing dimensions of a spoiler 24, an antenna conductor 6 and a ground conductor 16 embedded in the spoiler 24 in Example 3.

### EXPLANATION OF NUMERALS

1: Left side bus bar
1H: Bus bar horizontal portion
1K: Bus bar beak-like portion
1V: Bus bar vertical portion
4: Anti-freeze heater wire for wiper
12: Vertical heater wire
3H: Inside horizontal bus bar
3V: Inside vertical bus bar
6: Antenna conductor
7: Heater wire
12: Inside heater wire
12a: Inside heater wire at the highest position
14: Rear window glass plate for an automobile
20: Left virtual plane
21: Right virtual plane
From now, a high frequency wave glass antenna for an automobile of the present invention is described in detail with reference to suitable embodiments shown in the attached drawings. FIG. 1 (car-interior view or car-exterior view) is a front view showing an embodiment of a high frequency wave glass antenna for an automobile of the present invention. In FIG. 1 and Figures to be described, a direction means a direction on each drawing.

In FIG. 1, 1 indicates a left side bus bar, 1H indicates a bus bar horizontal portion, 1K indicates a bus bar beak-like portion, 1V indicates a bus bar vertical portion, 2 indicates a vertical heater wire, 4 indicates an anti-freeze heater wire for a wiper, 3H indicates an inside horizontal bus bar, 3V indicates an inside vertical bus bar, 5 indicates a short circuit wire, 6 indicates an antenna conductor, 7 indicates a heater wire, 12 indicates an inside heater wire, 12a indicates an inside heater wire at the highest position, 14 indicates a rear window glass plate of an automobile, 20 indicates a left virtual plane and 21 indicates a right virtual plane.

FIG. 1 shows a left side region of the rear window glass plate 14. In the example shown in FIG. 1, the left side region and a right side region are symmetric to each other with respect to the left-right center of the rear window glass plate 14. However, the shape is not necessarily limited thereto, and they are not necessarily symmetric to each other.

In the present invention, on the rear window glass plate, a plurality of heater wires and a plurality of bus bars for supplying a power to the heater wires, are provided. The plurality of heater wires and the plurality of bus bars constitute a defogger.

In the example shown in FIG. 1, a part of the plurality of heater wires extend in a horizontal direction or a substantially horizontal direction. The antenna conductor 6 may be provided in a blank region in an upper portion of the rear window glass plate 14 other than the defogger region, or it may be provided in the vicinity of the rear window glass plate 14.

In a case where the antenna conductor 6 is provided in the blank region in the upper portion of the rear window glass plate 14, the antenna conductor 6 is preferably provided at least one of the left side upper blank region or the right side upper blank region, for the reasons of improving directivity and convenience for assembly.

In a case where the antenna conductor 6 is provided in the vicinity of the rear window glass plate 14, the antenna conductor 6 is preferably provided in spoiler provided in the upper rear portion of the automobile body in the vicinity of the rear window glass plate, for the reason of e.g. convenience of assembly. However, the position is not necessarily limited thereto, and the antenna conductor 6 may be attached to a part of the automobile body in the vicinity of the rear window glass plate 14.

In the example shown in FIG. 1, the antenna conductor 6 is a monopole antenna. However, the type of antenna is not necessarily limited thereto, and the antenna may be a dipole antenna having an antenna conductor and a ground conductor (refer to e.g. FIG. 3 to be described later). In a case of employing a dipole antenna, a receive signal between the antenna conductor and the ground conductor is sent to a receiver (not shown).

In the present invention at least one of the plurality of bus bars has a bus bar horizontal portion 1H extending in a horizontal direction or a substantially horizontal direction. The bus bar horizontal portion 1H is provided in the upper region of the rear glass window plate 14. A plurality of vertical heater wires 2 are provided, which extend in a vertical direction or a substantially vertical direction from the bus bar horizontal portion 1H.

In the example shown in FIG. 1, a bus bar 1 has a bus bar vertical portion 1V extending in a vertical direction or a substantially vertical direction in a left side region. The upper portion of the bus bar vertical portion 1V turns towards the left-right center of the rear window glass plate 14, to constitute a bus bar horizontal portion 1H. Further, in the lowermost portion of the bus bar vertical portion 1V, a bus bar beak-like portion 1K extending upwardly in the inside of the defogger is provided. The bus bar beak-like portion 1K has a function of unifying electricity supplied to the heater wires 7, and is provided as the case requires.

Further, below the bus bar horizontal portion 1H, an inside horizontal bus bar 3H extending in a horizontal direction or a substantially horizontal direction is provided, and the inside horizontal bus bar 3H and the bus bar horizontal portion 1H are connected by a plurality of vertical heater wires 2. The vertical heater wires 2 extend in a vertical direction or a substantially vertical direction. The antenna conductor 6 is preferably provided above the bus bar horizontal portion 1H for the reason that the antenna gain can be improved. Further, in order to improve antenna gain, the antenna conductor 6 is preferably provided in at least one of the upper left portion or the upper right portion of the rear window glass plate 14.

Further, an inside vertical bus bar 3V is preferably provided, which extends upwardly from an end of the inside horizontal bus bar 3H in the left-right center side of the rear window glass plate 14 or its vicinity, and internal heater wires 12 are preferably provided, which extend in a horizontal direction or a substantially horizontal direction from the inside vertical bus bar 3V. This is because in such a construction, it becomes possible to defog the left-right central region of the rear window glass plate 14 to maintain visibility. Here, an anti-freeze heater wire 4 for wiper has a function of anti-freeze of wiper when a wiper is provided on the upper portion of the rear window glass plate 14. However, the construction is not necessarily limited thereto, and for example, when no wiper is provided, the heater wire may be used as a heater wire for defogging the rear window glass plate.

A plane parallel with the longitudinal direction and the vertical direction of an automobile, that is tangent to the left end of the antenna conductor 6, is defined as a left virtual plane 20. Further, a plane parallel with the longitudinal direction and the vertical direction of an automobile, that is tangent to a right end of the antenna conductor 6, is defined as a right virtual plane. Then, at least one of the plurality of vertical heater wires is preferably provided between the left virtual plane 20 and the right virtual plane 21 on the rear window glass plate 14, for the reason of improving antenna gain.

In the present invention, the intervals of the plurality of vertical heater wires 2 are preferably from 19 to 39 mm for the reason of defogging performance to maintain visibility. In this region, more preferred region is from 24 to 34 mm, particularly preferred region is from 26 to 32 mm, the most preferred region is from 27.5 to 30.5 mm.

It is preferred that (D_{LR}/λ_{g}) is at least 0.32 and D_{LR} is at most 450 mm provided that the wavelength in the air at a frequency in a desired frequency band to be received by the antenna conductor is designated as λ₀, the glass wavelength shrinkage ratio is designated as k that is k=0.64, λ_{g} is defined as λ_{g}=λ₀·k, and provided that the average distance between the leftmost vertical heater wire and the rightmost vertical heater wire among the vertical heater wires is designated as D_{LR}. The value (D_{LR}/λ_{g}) is preferably at least 0.32 to improve an antenna gain as compared with a case where it is less than 0.32. D_{LR} is preferably at most 450 mm for the reasons that an antenna gain can be improved, the bus bar does not become too long and convenience for assembly is maintained as compared with a case where the value exceeds 450 mm.

These values are preferably such that (D_{LR}/λ_{g}) is at least 0.39 and D_{LR} is at most 400 nm, particularly preferably such that (D_{LR}/λ_{g}) is at least 0.45 and D_{LR} is at most 350 nm, the most preferably such that (D_{LR}/λ_{g}) is at least 0.48 and D_{LR} is at most 300 nm.

Provided that the average length of the plurality of vertical heater wires 2 is designated as L_{V}, (L_{V}/λ_{g}) is preferably from 0.16 to 0.92 for the purpose of improving antenna gain. Within this range, the more preferred range is from 0.23 to 0.84, particularly preferred range is from 0.29 to 0.71.

In the present invention, λ₀ is preferably a wavelength in an air at a center frequency in a desired frequency band, for the purpose of improving antenna gain in the entire region of the wavelength band.

In a case of receiving entire region of Japanese terrestrial digital TV broadcasting, λ₀ is preferably a wavelength in an air at a frequency of 620 MHz.

In a case of receiving the present broadcasting region (470 to 600 MHZ) of Japanese terrestrial digital TV broadcasting, λ₀ is preferably a wavelength in an air at a frequency of 535 MHz.

In a case of receiving the main region (470 to 710 MHz) of Japanese terrestrial digital TV broadcasting, λ₀ is preferably a wavelength in an air at a frequency of 590 MHz.

FIG. 3 is a side view showing an upper rear side portion of an automobile in an embodiment of high frequency wave glass antenna for an automobile of the present invention, which includes the embodiment shown in FIG. 1. In FIG. 3, 15a indicates an upper rear portion of an automobile, 16 indicates a ground conductor, 24 indicates a spoiler, and 25 indicates a rearmost side window glass plate. On a rear window glass plate 14, a defogger portion other than an inside horizontal bus bar 3H is not shown and omitted.

In the example shown in FIG. 3, a spoiler 24 made of an insulative material is provided on an upper rear portion 15a of the automobile body. In the spoiler 24, an antenna conductor 6 and a ground conductor 16 are embedded. However, the construction is not necessarily limited thereto, and the construction may be such that at least one of the antenna conductor 6 and the ground conductor 16 is provided on a surface of the spoiler 24. The material of the spoiler 24 is preferably an insulative material, and it may, for example, be a synthesized resin.

Further, the antenna provided on the spoiler 24 is a dipole antenna. However, the antenna is not necessarily limited thereto, and it may be a monopole antenna in which only the antenna conductor 6 is provided in the spoiler 24.

In a case where the antenna conductor 6 is provided in the spoiler, the antenna conductor 6 preferably extends along a surface of a rear window glass for the purpose of improving antenna gain. The minimum distance between a vertical heater wire 2 and the antenna conductor 6 is preferably at most 500 mm, particularly preferably at most 300 mm for the purpose of downsizing and convenience for assembly.

In the present invention, in a case of receiving the digital TV broadcast band, the shape and the size of the is antenna conductor 6 is preferably configured to have a receiving function of digital TV broadcast band, for the purpose of improving antenna gain.

In the present invention, a part or all of the antenna conductor 6 (when the antenna conductor 6 is provided on the rear window glass plate 14) or a part of defogger, may be provided on a shielding film being a dielectric film formed on the rear window glass plate 14. The shielding film may, for example, be a ceramic film such as a black ceramic film. In this case, since e.g. the antenna conductor 6 portion provided on the shielding film is shielded when it is observed from a car-exterior side of the rear window glass plate 14, the rear window glass plate 14 becomes excellent in design which shields the antenna system of the present invention when it is observed from a car-exterior side.

The antenna conductor 6, (when the antenna conductor 6 is provided on the rear window glass plat 14) and the defogger are usually formed by printing a paste such as a silver paste containing an electrically conductive metal on a car-interior surface of the rear window glass plate 14, and baking the paste. However, the forming method is not necessarily limited thereto, and it may be formed by forming a wire-shaped member or a foil-shaped member made of an electrically conductive material such as copper on a car-interior side surface or a car-exterior side surface of the rear window glass plate 14, or it may be embedded inside of the rear window glass plate 14 itself. Further, the antenna conductor 6 may be formed by laminating a synthetic resin film having a conductor layer in the film or on a surface of the film, on a car-interior side surface or a car-exterior side surface of the rear window glass plate 14.

### EXAMPLES

From now, the present invention will be described with reference to Examples, but the present invention is not limited to these Examples, and various improvements or modifications are included in the present invention so long as they do not depart from the gist of the present invention.

Examples are described in detail with reference to drawings.

### Example 1

### Example of the Present Invention

With respect to a high frequency wave antenna for an automobile shown in FIGS. 4 and 5, its antenna gain for horizontal polarization is calculated by a moment method. FIG. 4 is a front view of an upper left side half of a rear portion of an automobile, which is symmetric with respect to a left-right center of the rear window glass plate 14, and no antenna conductor is assumed to be provided in a right half. In FIG. 4, 15 indicates an automobile body, 26 indicates a dipole antenna of 275 mm, and symbols in the vicinity of arrows indicate lengths, distances or intervals.

FIG. 5 is a side view of the high frequency wave antenna for an automobile shown in FIG. 4. In FIG. 5, 15H indicates an upper edge of an automobile body opening for window, and 15L indicates a lower edge of an automobile body opening for window. In FIGS. 4 and 5, no anti-freeze heater wire for wiper is provided. In FIG. 5, symbols in the vicinity of arrows indicate lengths, distances or intervals. Further, a defogger portion other than the inside heater wire 12a at the highest portion is omitted and not described.

An antenna gain is defined as an average value of antenna gains at 1° intervals within a horizontal direction range of from −90° to +90° (automobile back side) provided that the automobile rear direction is designated as 0°, the automobile left direction is designated as +90° and the automobile front direction is designated as +180°. The frequencies for calculation is 10 MHz intervals in a range of from 470 to 770 MHz.

In FIG. 4, H₁ (parallel direction with the rear window glass plate 14) is fixed to 151 mm (six inside heater wires 12) which maximizes the antenna gain in a frequency range of from 470 to 770 MHz regardless of W₁ value, and the antenna gain is calculated as a function of W₁. The calculation is made under an assumption that intervals of vertical heater wires 2 are constant (each 29 mm), and that as W₁ increases, the length of the internal heater wires 12 decreases, and the number of vertical heater wires increases accordingly. The calculation is made under an assumption that as W₁ decreases, the length of the internal heater wires 12 increases, and the number of vertical heater wires decreases accordingly.

As calculation results, antenna gain-W₁ characteristic diagrams in respective frequency regions are shown in FIG. 6 (470 to 770 MHz), FIG. 7 (470 to 600 MHz) and FIG. 8 (470 to 710 MHz). Here, provided that λ₀ is a wavelength in an air at a frequency of 620 MHz, the value of W₁ at which (D_{LR}/λ_{g}) becomes 0.32 becomes approximately 100 mm.

Parameters such as dimensions of various portions in FIGS. 4 and 5 are as follows.

| D₁ (parallel direction with rear window glass plate | 50 | mm, |
|---|---|---|
| 14) | | |
| D₂ | 20 | mm, |
| D₃ | 30 | mm, |
| D₄ | 50 | mm, |
| D₅ | 30 | mm, |
| W₂ | 50 | mm, |
| W₃ (vertical width of an automobile body opening for | 500 | mm, |
| window) | | |
| L₁ (parallel direction with rear window glass plate | 30 | mm, |
| 14) | | |
| L₂ | 424 | mm, |
| L₃ | 624 | mm, |
| L₄ | 50 | mm, |
| L₅ | 200 | mm, |
| Interval between horizontal heater wires 2 | 29 | mm, |
| Distance between heater wire 7 at the highest | 29 | mm, |
| position and inside heater wire 12 at the lowest position | | |
| Interval between heater wires 7 and interval between | 29 | mm, |
| inside heater wires 12 | | |
| Line width of vertical heater wire 2, line width of | 1 | mm, |
| heater wire 7 and line width of inside heater wire 12 | | |
| α | 45°, | |
| Horizontal width of defogger | 1,300 | mm, |
| Horizontal width of automobile body 15 | 1,440 | mm, |
| Thickness of metal plate constituting automobile | 0.75 | mm. |
| body | | |

### Example 2

### Example of the Present Invention

Antenna gain is calculated as a function of H₁ in the same manner as Example 1 except that W₁ is fixed to 211 mm (eight vertical heater wires 2) maximizing the antenna gain in a frequency range of from 470 to 770 MHz regardless of the value of H₁.

When H₁ is changed, an interval between vertical heater wires 2, the distance between a heater wire 7 at the highest position and an internal heater wire 12 at the lowest position, an interval between heater wires 7, and an interval between inside heater wires 12, are each set to be constant (29 mm).

The antenna gain is calculated under assumption that as H₁ becomes longer, the number of inside heater wires 12 increases accordingly and the number of heater wires 7 decreases accordingly.

The antenna gain is calculated under assumption that as H₁ becomes shorter, the number of inside heater wires 12 decreases accordingly and the number of heater wires 7 increases accordingly. Conditions such as dimensions not specified are the same as those of Example 1.

As calculation results, antenna gain-H₁ characteristic diagrams in respective frequency ranges are shown in FIG. 9 (470 to 770 MHz), FIG. 10 (470 to 600 MHz) and FIG. 11 (470 to 710 MHz). Here, provided that λ₀ is a wavelength in the air at a frequency of 620 MHz, the value of H₁ at which (L_{V}/λ_{g}) becomes 0.16, becomes approximately 50 mm.

### Example 3

### Example of the Present Invention

A high frequency wave antenna for an automobile shown in FIGS. 3, 13 (car-interior view), 14 and 15 was produced. FIG. 14 is a partial enlarged side view in the vicinity of a rear window glass plate 14 shown in FIG. 3, and shows dimensions. FIG. 15 is a plan view showing dimensions of a spoiler 24, an antenna conductor 6 and a ground conductor 16 embedded in the spoiler 24 (in a case where the material of spoiler is transparent), and FIG. 15 shows a left half of the spoiler 24. In FIG. 15, 6a indicates a feeding point of the antenna conductor 6, 16a indicates a feeding point of the ground conductor. The upper direction in FIG. 15 indicates a forward direction of the automobile. Here, the spoiler 24 is symmetric with respect to the left-right center, and the antenna conductor 6 and the ground conductor 16 were provided also in a right half of the spoiler 24. FIG. 12 shows an antenna gain-frequency characteristic.

An antenna gain was defined as an average value of antenna gains (3° interval) in a horizontal direction range of from −90° to +90° (automobile back side) provided that the automobile rear direction is defined as 0°, the automobile right direction is defined as +90° and the automobile forward direction is defined as +180°. Dimensions of portions of the antenna are as follows.

| | | |
|---|---|---|
| Antenna conductor 6 | 80 × 100 | mm, |
| Ground conductor 16 | 40 × 200 | mm, |
| Interval between vertical heater wires 2 | 30 | mm, |
| Distance between heater wire 7 at the highest | 30 | mm, |
| position and inside heater wire 12 at the | | |
| lowest position | | |
| Interval between heater wires 7 and interval | 30 | mm, |
| between inside heater wires 12 | | |
| Distance between anti-freeze heater wire 4 and | 26 | mm, |
| inside heater wire 12a at the highest position | | |
| Bus bar vertical portion 1V | 5 to 20 | mm, |
| Bus bar horizontal portion 1H | 5 | mm, |
| D₁₀ | 10 | mm, |
| D₁₁ | 70 | mm, |
| Maximum horizontal width of defogger | 1,200 | mm, |
| Line width of anti-freeze heater 4 for wiper, | 0.7 | mm, |
| line width of heater wire 7, line width of | | |
| inside heater wire 12 and line width of short | | |
| circuit wire 5 | | |
| Line width of vertical heater wire 2 | 0.4 | mm. |
| L₁₀ | 370 | mm, |
| D₁₅ | 140 | mm, |
| D₂₁ | 20 | mm, |
| D₂₂ | 15 | mm, |
| D₂₃ | 55 | mm, |
| L₅₁ | 230 | mm, |
| L₅₂ | 190 | mm, |
| L₅₃ | 385 | mm, |
| L₅₄ | 220 | mm, |
| L₅₅ | 370 | mm, |
| Rear window glass plate 14 | 600 × 1,400 | mm. |

The present invention is used for a glass antenna for an automobile for receiving terrestrial digital TV broadcasting, analogue TV broadcasting in UHF band, digital TV broadcasting in U.S., digital TV broadcasting in EU region, or digital TV broadcasting in Peoples Republic of China. Further, the present invention is usable also for receiving FM broadcasting band in Japan (76 to 90 MHz), FM broadcast band in U.S. (88 to 108 MHz), VHF band for TV (90 to 108 MHz, 170 to 222 MHz), 800 MHz band for automobile phone (810 to 960 MHz), 1.5 GHz band for automobile phone (1.429 to 1.501 GHz), UHF band (300 MHz to 3 GHz), GPS (global positioning system), or GPS signal of satellite (1,575.42 MHz).

Further, the present invention is usable for DSRC (Dedicated Short Range Communication, 915 MHz band) or communication for automobile keyless entry system (300 to 450 MHz).

The entire disclosure of Japanese Patent Application No. 2007-179706 filed on Jul. 9, 2007 including specification, claims, drawings and summary is incorporated herein by reference in its entirety.

What is claimed is:

1. A high frequency wave antenna for an automobile, comprising a plurality of heater wires and a plurality of bus bars for supplying electricity to the plurality of heater wires, the heater wires and the bus bars being provided on a rear window glass plate for an automobile, the heater wires and the bus bars constitute a defogger, a part of the heater wires extending in a horizontal direction or a substantially horizontal direction, and the antenna comprising an antenna conductor provided on an upper blank space of the rear window glass plate or in the vicinity of the rear window glass plate, the antenna being characterized in that at least one of the bus bars has a bas bar horizontal portion extending in a horizontal direction or a substantially horizontal direction, the bus bar horizontal portion is provided in the upper region of the rear window glass, and a plurality of vertical heater wires extending in a vertical direction or a substantially vertical direction starting from the bus bar horizontal portion.

2. The high frequency antenna for an automobile according to claim 1, wherein the antenna conductor is provided in a spoiler provided in the upper rear portion of an automobile body in the vicinity of the rear window glass.

3. The high frequency antenna for an automobile according to claim 1, wherein at least one of the bus bars has a portion extending in a vertical direction or a substantially vertical direction in the right side region or the left side region of the rear window glass plate, and provided that the portion is designated as a bus bar vertical portion, the upper portion of the bus bar vertical portion turns and extends towards the left-right center of the rear window glass to constitute a bus bar horizontal portion.

4. The high frequency wave antenna for an automobile according to claim 1, wherein an inside horizontal bus bar extending in a horizontal direction or a substantially horizontal direction is provided below the bus bar horizontal portion, the inside horizontal bus bar and the bus bar horizontal portion are connected with the plurality of the vertical heater wires.

5. The high frequency wave antenna for an automobile according to claim 4, wherein an inside vertical bus bar is provided, which extends upwardly from an end or its vicinity of the inside horizontal bus bar that is in the left-right center side of the rear window glass, and an inside heater wire is provided, which extends in a horizontal direction or a substantially horizontal direction from the inside vertical bus bar.

6. The high frequency wave antenna for an automobile according to claim 1, wherein at least one of the heater wires is provided between a left vertual plane and a right vertual plane and on the rear window glass plate provided that a plane parallel with the longitudinal direction and the vertical direction of the automobile, that is tangent to the left end of the antenna conductor, is designated as the left vertual plane, and a plane parallel with the longitudinal direction and the vertical direction of the automobile, that is tangent to the right end of the antenna conductor, is designated as the right vertual plane.

7. The high frequency wave glass antenna for an automobile according to claim 1, wherein the intervals between the vertical heater wires are from 19 to 39 mm.

8. The high frequency wave antenna for an automobile according to claim 1, wherein (D_{LR}/λ_{g}) is at least 0.32 and D_{LR} is at most 450 mm provided that the wavelength in the air at a frequency in a desired frequency band to be received by the antenna conductor is designated as λ₀, the glass wavelength shrinkage ratio is designated as k that is k=0.64, λ_{g} is defined as λ_{g}=λ₀·k, and the average distance between the leftmost vertical heater wire and the rightmost vertical heater wire among the vertical heater wires is designated as D_{LR}.

9. The high frequency antenna for automobiles according to claim 1, wherein (L_{V}/λ_{g}) is from 0.16 to 0.92 provided that the wavelength in the air at a frequency in a desired frequency band to be received by the antenna conductor is designated as λ₀, the glass wavelength shrinkage ratio is designated as k that is k=0.64, λ_{g} is designated as λ_{g}=λ₀·k, and the average wire length of the plurality of vertical heater wires is designated as L_{V}.

10. The high frequency wave glass antenna for an automobile according to claim 8, wherein λ₀ is a wavelength in the air at a center frequency in the desired frequency band.

11. The high frequency wave glass antenna for an automobile according to claim 9, wherein λ₀ is a wavelength in the air at a center frequency in the desired frequency band.

12. The high frequency wave antenna for an automobile according to claim 2, wherein when the antenna conductor is provided in a spoiler, the antenna conductor extends along a surface of the rear window glass.

13. The high frequency wave glass antenna for an automobile according to claim 1, wherein the shape and the dimension of the antenna conductor are configured to provide a receiving function of the digital TV broadcast band.

14. The high frequency wave glass antenna for an automobile according to claim 1, wherein the frequency of electromagnetic wave to be received contains a frequency present between 470 and 770 MHz.

15. The high frequency wave glass antenna for an automobile according to claim 1, wherein the frequency of electromagnetic wave to be received contains a frequency present between 698 and 806 MHz.

16. A rear window glass for an automobile provided with the defogger as defined in claim 1.
